(19) United States
(12) Patent Application Publication
(10) Pub. No.: US 2026/0302178 A1
(43) Pub. Date: Oct. 1, 2026

(54) CYLINDRICAL BATTERY AND METHOD FOR PRODUCING SAME

(71) Applicant: Panasonic Intellectual Property Management Co., Ltd., Kadoma-shi, Osaka (JP)

(72) Inventors: Jerome Davis, Osaka (JP); Genichiro Kato, Kyoto (JP)

(73) Assignee: Panasonic Intellectual Property Management Co., Ltd., Kadoma-shi, Osaka (JP)

(21) Appl. No.: 19/475,950

(22) PCT Filed: Apr. 2, 2024
(86) PCT No.: PCT/JP2024/013645

§ 371 Date: Oct. 16, 2025

(30) Foreign Application Priority Data
Apr. 27, 2023 (JP) 2023-073741

(51) Int. Cl. H01M 4/36; H01M 4/02; H01M 10/04

(52) U.S. Cl. CPC H01M 4/364; H01M 10/0431; H01M 2004/021; H01M 2004/028

(57) ABSTRACT

This cylindrical battery includes an electrode body in which a long positive electrode having a positive electrode core body and a positive electrode mixture layer, and a long negative electrode having a negative electrode core body and a negative electrode mixture layer are wound together with a separator interposed therebetween. The positive electrode mixture layer has a thin portion extending from the starting end on the winding start side across a prescribed range in the winding direction, the thickness of the thin portion is less than the thickness of a main portion, which is the portion of the positive electrode mixture layer other than the thin portion, and the adhesion strength of the positive electrode mixture layer to the positive electrode core body is higher in the thin portion than in the main portion.

### TECHNICAL FIELD

The present disclosure relates to a cylindrical battery and a method of producing the same.

### BACKGROUND ART

A cylindrical battery comprises a wound-type electrode assembly that includes a positive electrode and a negative electrode that are spirally wound with a separator intervening therebetween. If the cylindrical battery is subjected to repetitive charging and discharging cycles, the positive electrode and the negative electrode are expanded and contracted, an electrode plate deformation where at least one of the positive electrode and the negative electrode is locally deformed sometimes occurs.

For example, Patent Literature 1 discloses a cylindrical battery comprising a wound-type electrode assembly that includes insulating tape pasted to a negative electrode so as to be across the surface of a negative electrode lead in the winding direction in order to prevent the deformation of a joined portion of the negative electrode lead.

### CITATION LIST

### Patent Literature

PATENT LITERATURE 1: International Publication No. WO 2018/180748

### SUMMARY

Incidentally, in the cylindrical battery, the winding-start-side end portion of the positive electrode is formed as a large step along the winding direction. Consequently, according to the charging and discharging cycle, the negative electrode portion facing the winding inner side of the winding-start-side end portion of the positive electrode sometimes deforms. If the negative electrode portion deforms, the distance between the positive and negative electrodes varies, and the charging and discharging reaction becomes uneven, thus possibly degrading the cycle characteristics.

The insulating tape in Patent Literature 1 cannot sufficiently prevent the deformation of the negative electrode portion that faces the winding inner side of the positive electrode winding-start-side end serving as the step described above in some cases. On the other hand, it is conceivable that at the winding-start-side end portion of the positive electrode mixture layer, a thin portion having a smaller thickness than the other portions of the positive electrode mixture layer is provided. However, in the case of simply providing the thin portion at the winding-start-side end portion of the positive electrode mixture layer, the positive electrode mixture layer at the thin portion is possibly prone to peeling off the positive electrode core. Accordingly, a cylindrical battery and a method of producing the same that can secure the durability, and prevent the electrode plate deformation at the negative electrode portion facing the winding inner side of the positive electrode winding-start-side end portion are desired to be achieved.

A cylindrical battery according to the present disclosure is a cylindrical battery comprising an electrode assembly that includes: an elongated positive electrode that includes a positive electrode core and a positive electrode mixture layer; and an elongated negative electrode that includes a negative electrode core and a negative electrode mixture layer, the electrodes being wound with a separator intervening therebetween, wherein the positive electrode mixture layer includes a thin portion in a predetermined range from a winding-start-side start end in a winding direction, a thickness of the thin portion is smaller than a thickness of a main portion that is a portion of the positive electrode mixture layer other than the thin portion, and a close contact strength of the positive electrode mixture layer with the positive electrode core is higher at the thin portion than at the main portion.

A method of producing a cylindrical battery according to the present disclosure is a method of producing a cylindrical battery, wherein the cylindrical battery is a cylindrical battery according to the present disclosure, and the thin portion is formed by irradiating the positive electrode mixture layer with laser light.

According to the cylindrical battery and the method of producing the same according to the present disclosure, the durability of the cylindrical battery may be secured, and the electrode plate deformation at the negative electrode portion facing the winding inner side of the positive electrode winding-start-side end portion may be prevented.

### BRIEF DESCRIPTION OF DRAWING

FIG. 1 is a sectional view of a cylindrical battery that is an example of an embodiment.

FIG. 2 is a sectional view taken at the width-direction center of a winding-start-side end portion in a case where a positive electrode and a negative electrode are longitudinally developed in one example of the embodiment.

FIG. 3 is a perspective view of a part including the positive electrode winding-start end portion in the longitudinal direction in one example of the embodiment.

FIG. 4 is a sectional view taken along A-A in FIG. 3.

FIG. 5 is a diagram showing a cutting position on a positive electrode intermediate material before being cut into the dimension of the positive electrode, viewed from the winding inner side, in one example of the embodiment.

FIG. 6 is a diagram that shows a positive electrode included in a cylindrical battery as another example of the embodiment and corresponds to FIG. 4.

### DESCRIPTION OF EMBODIMENTS

Referring to the drawings, an embodiment of a cylindrical battery according to the present disclosure is described below in detail. Note that the cylindrical battery in the present disclosure may be a battery that uses aqueous electrolyte, or a battery that uses non-aqueous electrolyte. In the following, a non-aqueous electrolyte secondary battery (lithium-ion battery) that uses non-aqueous electrolyte is described below as a cylindrical battery 10 that is an embodiment. However, the cylindrical battery in the present disclosure is not limited to this. The electrolyte may be aqueous electrolyte.

It is originally assumed that the characteristic portions of the embodiment and modified examples described below are combined as appropriate, and a new embodiment is constructed. In the following embodiment, the same configuration is assigned the same symbol in the diagram, and redundant description is omitted. The plurality of drawings include schematic diagrams. Among different diagrams, the ratios of longitudinal, lateral, and height dimensions and the like of the members do not necessarily match. In the present Description, the side of the axial direction (height direction) of the cylindrical battery 10 where the sealing assembly 17 is present is defined as “upper”, and the side of the axial direction where the bottom portion 31 is present is defined as “lower”. Among the configuration elements described below, configuration elements that are not described in an independent claim representing the highest-level concept are arbitrary configuration elements, and are not necessary configuration elements.

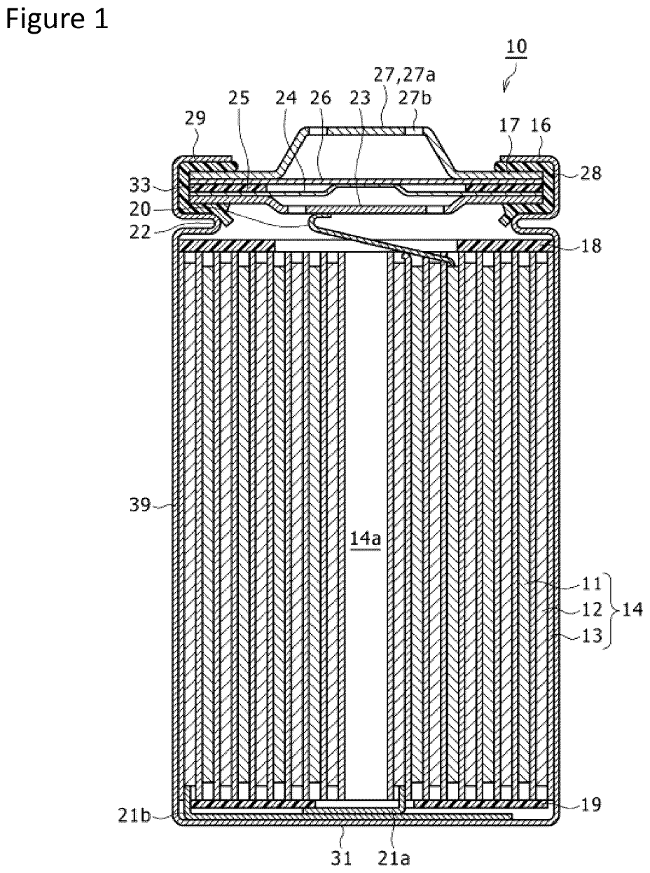

FIG. 1 is a sectional view of a cylindrical battery 10 in the axial direction according to one embodiment of the present disclosure. As shown in FIG. 1, the cylindrical battery 10 includes: an electrode assembly 14; a bottomed cylindrical outer housing can 16 that accommodates the electrode assembly 14; and a sealing assembly 17 that blocks an opening portion of the canouter housing can 16. The outer housing can 16 houses non-aqueous electrolyte along with the electrode assembly 14. The outer housing can 16 includes, at its upper end portion, a shoulder portion 29 that is bent inward in the radial direction and extends inward. The outer housing can 16 includes a grooved portion 22 formed in a side wall, and the sealing assembly 17 is supported by the grooved portion 22 and blocks an opening portion of the outer housing can 16.

The cylindrical battery 10 further comprises a gasket 28 that intervenes between the outer housing can 16 and the sealing assembly 17. The gasket 28 is a ring-shaped plastic member attached to an outer peripheral portion of the sealing assembly 17, and insulates the sealing assembly 17 from the outer housing can 16. The gasket 28 blocks the gap between the outer housing can 16 and the sealing assembly 17, and seals the inside of the battery.

The non-aqueous electrolyte contains a non-aqueous solvent, and electrolyte salt dissolved in the non-aqueous solvent. The non-aqueous solvent may be, for example, any of esters, ethers, nitriles, or amides, a mixed solvent of two or more of them, or the like. The non-aqueous solvent may contain a halogenated compound made by replacing at least some of hydrogen atoms of the solvent with halogen atoms, such as fluorine. Examples of the non-aqueous solvent include ethylene carbonate (EC), ethyl methyl carbonate (EMC), dimethyl carbonate (DMC), a mixed solvent of them and the like. The electrolyte salt may be, for example, lithium salt, such as LiPF₆. Note that the non-aqueous electrolyte is not limited to liquid electrolyte, and may be solid electrolyte instead.

An electrode assembly 14 includes a positive electrode 11, a negative electrode 12, and a separator 13, and has a wound structure where the positive electrode 11 and the negative electrode 12 are spirally wound with the separator 13 intervening therebetween. The positive electrode 11, the negative electrode 12, and the separator 13 are strip-shaped elongated bodies, and are spirally wound, thus being alternately stacked in the radial direction of the electrode assembly 14. The negative electrode 12 is formed to have a dimension one size larger than the positive electrode 11 in order to prevent lithium from depositing. That is, the negative electrode 12 is formed to be longer in the longitudinal direction and the width direction than the positive electrode 11. The separator 13 is formed to have a dimension at least one size larger than the positive electrode 11. For example, two separators 13 are disposed so as to sandwich the positive electrode 11.

A positive electrode lead 20, and two negative electrode leads 21a and 21b are connected to the electrode assembly 14. The positive electrode lead 20 electrically connects the positive electrode 11 and the sealing assembly 17 to each other. The first negative electrode lead 21a is joined to the winding-start-side end portion of the negative electrode 12, and electrically connects the winding-start-side end portion and the bottom portion 31 of the outer housing can 16 to each other. The second negative electrode lead 21b is joined to the winding-end-side end portion of the negative electrode 12, and electrically connects the winding-end-side end portion and the bottom portion 31 of the outer housing can 16 to each other.

In the example shown in FIG. 1, the positive electrode lead 20 extends toward the sealing assembly 17 through an opening portion of an upper insulating plate 18, and is joined to the lower surface of the sealing assembly 17. The first negative electrode lead 21a is bent toward a hollow portion 14a of the electrode assembly 14 through a through-hole of a ring-shaped lower insulating plate 19. The second negative electrode lead 21b passes through the outside of the lower insulating plate 19, and is bent so as to overlap the first negative electrode lead 21a. The overlapping portion of the first negative electrode lead 21a and the second negative electrode lead 21b is resistance-welded using a welding rod inserted through the hollow portion 14a of the electrode assembly 14, and is joined to the inner surface of the bottom portion 31 of the outer housing can 16.

When the negative electrode leads 21a and 21b are joined to the opposite ends of the negative electrode 12 in the longitudinal direction, the current collection path of the negative electrode 12 becomes short, which reduces the internal resistance of the cylindrical battery 10. Note that the negative electrode lead may be joined only to the winding-end-side end portion of the negative electrode in the longitudinal direction. Alternatively, the negative electrode lead may be joined only to the winding-start-side end portion of the negative electrode in the longitudinal direction, and the outermost turn core exposed portion of the negative electrode core that is positioned at at least part of the outermost turn of the electrode assembly may be in contact with the inner-peripheral surface of the outer housing can 16.

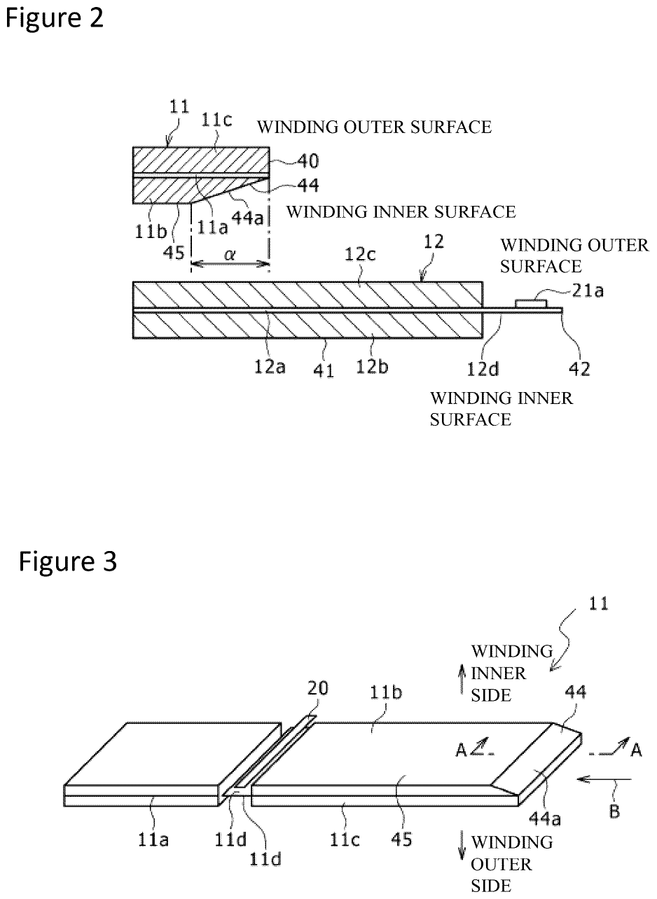

FIG. 2 is a sectional view taken at the width-direction center of a winding-start-side end portion in a case where the positive electrode 11 and the negative electrode 12 are longitudinally developed. FIG. 3 is a perspective view of a part including the winding-start end portion of the positive electrode 11 in the longitudinal direction.

As shown in FIG. 2 and FIG. 3, the positive electrode 11 includes a positive electrode core 11a, and positive electrode mixture layers 11b and 11e formed on at least one surface of the positive electrode core 11a. The positive electrode core 11a may be made of metal foil that is stable in the potential range of the positive electrode 11, such as of aluminum or an aluminum alloy, a film on which the metal is disposed as the surface layer, or the like. Preferably, the positive electrode mixture layer contains a positive-electrode active material, a conductive agent such as acetylene black, and a binding agent such as polyvinylidene fluoride (PVdF), and is formed on each of the opposite surfaces of the positive electrode core 11a. For example, a lithium transition metal composite oxide containing Ni, Co, Mn, Al or the like is used as the positive-electrode active material. While the positive electrode lead 20 is connected to the positive electrode 11, it is preferable that the positive electrode lead 20 should be directly connected to the positive electrode core 11a by ultrasonic welding or the like, and the joint portion to the positive electrode core 11a should be covered with insulating tape. As shown in FIG. 3, core exposed portions 11d are respectively formed on the thickness-direction opposite side surfaces at the longitudinal-direction center portion of the positive electrode 11. The positive electrode lead 20 is joined to one core exposed portion 11d. The positive electrode mixture layer may be formed only on one surface of the positive electrode core 11a, for example, the winding inner surface.

As shown in FIG. 2, the negative electrode 12 includes: a negative electrode core 12a; and negative electrode mixture layers 12b and 12c formed on at least one surface of the negative electrode core 12a. The negative electrode core 12a may be made of metal foil that is stable in the potential range of the negative electrode 12, such as of copper or a copper alloy, a film on which the metal is disposed as the surface layer, or the like. Preferably, the negative electrode mixture layers 12b and 12c contain a negative-electrode active material, and a binding agent, such as styrene-butadiene rubber (SBR) or PVdF, and is formed on each of the opposite surfaces of the negative electrode core 12a. For example, graphite, a silicon-containing compound or the like is used as the negative-electrode active material. Preferably, the negative electrode leads 21a and 21b are directly joined to the negative electrode core 12a by ultrasonic welding or the like, and the joint portion to the negative electrode core 12a is covered with insulating tape. The negative electrode mixture layer may be formed only on one surface of the negative electrode core 12a, for example, the winding outer surface.

Referring to FIG. 1, the outer housing can 16 is typically made of metal, with iron as the principal component, for example, a material made by plating iron with nickel, but may be made of metal, with aluminum or the like as the principal component, instead. The outer housing can 16 includes the cylindrical portion 39 and the bottom portion 31. The cylindrical portion 39 includes the ring-shaped grooved portion 22 and the ring-shaped shoulder portion 29. The grooved portion 22 is formed by depressing part of the cylindrical portion 39 inward in the radial direction by a spinning process. The shoulder portion 29 is formed when an upper end portion (an end portion on one side in the axial direction) of the cylindrical portion 39 is bent inward in the radial direction and crimped to a peripheral edge portion 33 of the sealing assembly 17, and extends inward in the radial direction at the upper end portion of the cylindrical portion 39.

The sealing assembly 17 is sandwiched by the shoulder portion 29 and the grooved portion 22 via the gasket 28 by crimping, thus being fixed to the outer housing can 16. The grooved portion 22 is formed at a position apart from the upper end of the outer housing can 16 by a predetermined length.

The sealing assembly 17 has a structure that includes a terminal plate 23, a lower vent member 24, an insulating plate 25, an upper vent member 26, and a sealing plate 27 stacked in this order from the electrode assembly 14 side. The members constituting the sealing assembly 17 each have, for example, a disk shape or a ring shape. Each of the members except the insulating plate 25 are electrically connected to each other. The sealing plate 27 has a convex shape where a center portion in the radial direction protrudes outward. A projection 27a of the sealing plate 27 includes an inclined surface portion formed into a ring shape, and a flat top surface portion surrounded by the inclined surface portion. One or more vent holes 27b are formed in the top surface portion.

The lower vent member 24, the insulating plate 25, and the upper vent member 26 constitute a current blocking mechanism. The lower vent member 24 and the upper vent member 26 are connected to each other at their center portions, and the insulating plate 25 intervenes between their peripheral edge portions. Possible increase in the internal pressure due to occurrence of an abnormality in the cylindrical battery 10 causes the lower vent member 24 to be deformed to push up the upper vent member 26 toward the sealing plate 27 and to be broken, thereby breaking the current path between the lower vent member 24 and the upper vent member 26. Further increase in the internal pressure breaks the upper vent member 26, and gas is exhausted through the vent holes 27b of the sealing plate 27.

In the present embodiment, the positive electrode lead 20 is connected to the lower surface of the terminal plate 23 by welding, ultrasonic welding or the like, and the sealing plate 27 that is a top plate of the sealing assembly 17 and is electrically connected to the terminal plate 23 serves as a positive electrode terminal. The outer housing can 16 to which the negative electrode leads 21a and 21b are joined serves as a negative electrode terminal.

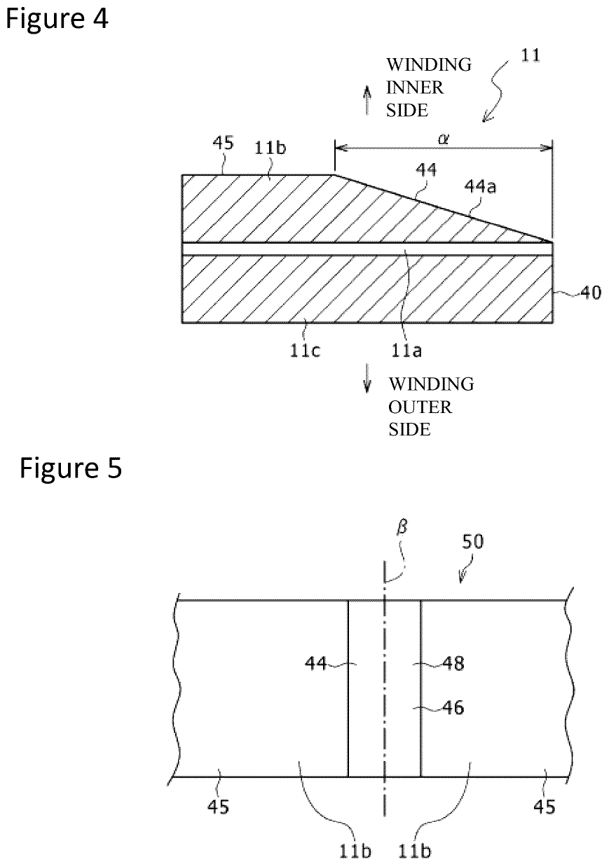

Next, referring to FIGS. 2 to 5, the structure of the positive electrode 11, and the arrangement position of the positive electrode 11 with respect to the negative electrode 12 are described in detail. FIG. 4 is a sectional view taken along A-A in FIG. 3.

As shown in FIG. 2, the negative electrode 12 includes: the negative electrode mixture layer 12b, 12c formed at least one surface of the negative electrode core 12a on the winding-start side of the electrode assembly 14; and a non-facing portion 41 wound to have 0.2 turns or more in a state of not facing the positive electrode 11.

Preferably, the non-facing portion 41 of the negative electrode 12 is wound to have 0.75 turns or more on the winding-start side of the electrode assembly 14. The non-facing portion 41 includes the negative electrode mixture layers 12b and 12c, but does not face the positive electrode 11. Accordingly, the non-facing portion 41 does not contribute to charging and discharging of the battery. On the other hand, the non-facing portion 41 has a high stiffness because of presence of the negative electrode mixture layer 12b, contributes to the stabilization of the shape of the winding core portion of the electrode assembly 14, and secures an exhaust path for gas occurring in case of occurrence of abnormality of the battery. In FIG. 2, illustration of the separator 13 is omitted.

At the non-facing portion 41, the negative electrode mixture layers 12b, 12c may be formed at least any one of the winding inner surface of the negative electrode core 12a that is oriented in the direction toward the winding center, and the winding outer surface of the negative electrode core 12a that is oriented in the direction toward the side wall of the outer housing can 16. Preferably, the negative electrode mixture layers 12b and 12c are formed on both the winding inner surface and the winding outer surface. In this case, the shape stability of the winding core portion is further improved. Preferably, for example, the non-facing portion 41 is formed to have a length greater than or equal to 0.75 turns and less than or equal to 1.5 turns, more preferably, greater than or equal to 0.90 turns and less than or equal to 1.4 turns, and particularly preferably, greater than or equal to 1.0 turn and less than or equal to 1.3 turns. In this case, it is easy to secure a favorable exhaust path in the winding core portion.

The negative electrode 12 includes a core exposed portion 12d that is a portion from a start end 42 to the non-facing portion 41. Similar to the non-facing portion 41, the core exposed portion 12d is a portion that does not face the positive electrode 11, but is different from the non-facing portion 41 in that the negative electrode mixture layers 12b and 12c are not included and only the negative electrode core 12a is included. In the present embodiment, the negative electrode lead 21a is joined to the core exposed portion 12d. In a case where the negative electrode lead 21a is arranged at the winding core portion of the electrode assembly 14, portions facing the positive and negative electrodes are prone to occurrence of deformation during charging and discharging. According to the present embodiment, such deformation can be effectively prevented.

The length of the core exposed portion 12d is not specifically limited. However, in view of securing the joined area of the negative electrode lead 21a, it is preferable to have a length greater than or equal to 0.5 turns. The core exposed portion 12d may be formed to have a length greater than or equal to 0.5 turns and less than or equal to 1.0 turn. The negative electrode lead 21a is, for example, a metal thin plate containing metal, such as nickel, as a principal component, and has a thickness greater than or equal to 50 μm and less than or equal to 100 μm. The negative electrode lead 21a is joined to the winding outer surface of the core exposed portion 12d at, for example, a position away from the start end 42 and the non-facing portion 41 of the negative electrode 12.

In the embodiment, as shown in FIGS. 2 to 4, the positive electrode mixture layer 11b on the winding inner side includes a thin portion 44 in a predetermined range (a range indicated by an arrow α in FIGS. 2 and 4) in the longitudinal direction corresponding to the winding direction from a winding-start-side start end 40. The predetermined range is at the winding-start side end portion of the positive electrode mixture layer 11b, for example. The thickness of the thin portion 44 is less than the thickness of the main portion 45 that is a portion of the winding-inner-side positive electrode mixture layer 11b other than the thin portion 44. In the present embodiment, the thickness of the thin portion 44 gradually decreases toward the start end 40, and the thickness is zero at the start end 40. The positive electrode mixture layer 11b may be formed at the start end 40. The side surface 44a on the thickness-direction outer side of the thin portion 44 is an inclined surface that is inclined from the side surface of the core 11a. By the thin portion 44, the electrode reaction at the portion facing the negative electrode 12 can be prevented. Accordingly, the expansion and contraction amount during charging and discharging of the battery can be reduced. Consequently, the electrode plate deformation at the portion of the negative electrode 12 that faces the winding inner side at the winding-start-side end portion of the positive electrode 11 can be prevented. The thin portion 44 is provided in the winding inner side of the positive electrode 11. Accordingly, the effect of preventing the electrode plate deformation of the negative electrode 12 portion that faces the winding inner side at the winding-start-side end portion of the positive electrode 11 becomes significant. The thickness of the thin portion 44 gradually decreases toward the start end 40. Accordingly, the winding-start-side end portion of the positive electrode 11 can be prevented from being formed as a large step along the winding direction. Consequently, according to the charging and discharging cycle, the deformation of the negative electrode portion that faces the winding inner side at the winding-start-side end portion of the positive electrode can be further prevented.

Note that similar to the positive electrode mixture layer 11b on the winding inner side, a thin portion may be provided for the positive electrode 11 in a longitudinal-direction predetermined range from the winding-start-side start end of the positive electrode mixture layer 11b on the winding outer side.

Furthermore, the contact strength of the positive electrode mixture layer 11b with the positive electrode core 11a is higher at the thin portion 44 than at the main portion 45. This can prevent the thin portion 44 from being prone to peeling off the positive electrode core 11a. Consequently, the durability of the battery can be secured.

To improve the contact strength of the thin portion 44 as described above, the method of producing the cylindrical battery in this example forms the thin portion 44 by irradiating the longitudinal-direction predetermined range from the winding-start-side start end of the positive electrode mixture layer 11b with laser light.

FIG. 5 is a diagram showing a cutting position on a positive electrode intermediate material 50 before being cut into the dimension of the positive electrode 11, viewed from the winding inner side. For example, the thin portion 44 can be formed by irradiating the positive electrode intermediate material 50 with laser light. Specifically, the positive electrode mixture layer 11b is irradiated with laser light over the entire width direction such that a valley shape having a V-section can be formed over the entire width direction centered on a cut portion indicated by a dash-dotted line β. In this case, the laser light irradiation position may be reciprocally moved in the width direction or the longitudinal direction of the positive electrode intermediate material 50 while the output and focal point of the laser light are adjusted. Accordingly, the valley-shaped internal portion is removed from the positive electrode mixture layer 11b with laser light, and the valley portion 46 is formed. The positive electrode intermediate material 50 is then cut along the dash-dotted line β, thereby achieving the positive electrode 11 where the thin portion 44 is formed in the predetermined range from the winding-start-side start end of the positive electrode mixture layer 11b. In this case, as shown in FIG. 5, a thin portion 48 is formed in a predetermined range from the winding-end-side end of the positive electrode 11. Note that in a range of the positive electrode mixture layer 11b that is irradiated with laser light, the binding agent is fused and solidified. Accordingly, the thin portion 44 has a higher close contact strength of the positive electrode mixture layer 11b with the positive electrode core 11a than the main portion 45 does.

On the other hand, unlike the embodiment, when a positive electrode mixture slurry that contains a positive-electrode active material, a conductive agent and a binding agent, and a dispersion medium is applied to the positive electrode core to form the positive electrode mixture layer, it is also conceivable to form the thin portion 44 by making the amount of application of the positive electrode mixture slurry smaller at the winding-start-side end portion of the positive electrode 11 than at the other portions. However, in this case, in the case of pressure compression using a roller press after application of the positive electrode mixture slurry to the positive electrode core, it is difficult to pressurize the thin portion 44 evenly with the other portions. Accordingly, it is difficult to make the close contact strength of the thin portion 44 higher than that of the other portions.

Preferably, the length of the thin portion 44 in the longitudinal direction of the positive electrode 11 is the winding length greater than or equal to 0.05 turns and less than one turn. Preferably, the average thickness of the thin portion 44 in the longitudinal direction of the positive electrode 11 is less than or equal to 70% of the thickness of the main portion 45. In a case where the average thickness is less than or equal to 70% of the thickness of the main portion 45, the effect of reducing the expansion and contraction amount during charging and discharging of the battery becomes high. On the other hand, in a case where the average thickness exceeds 70% of the thickness of the main portion 45, the effect of reducing the expansion and contraction amount during charging and discharging of the battery significantly decreases.

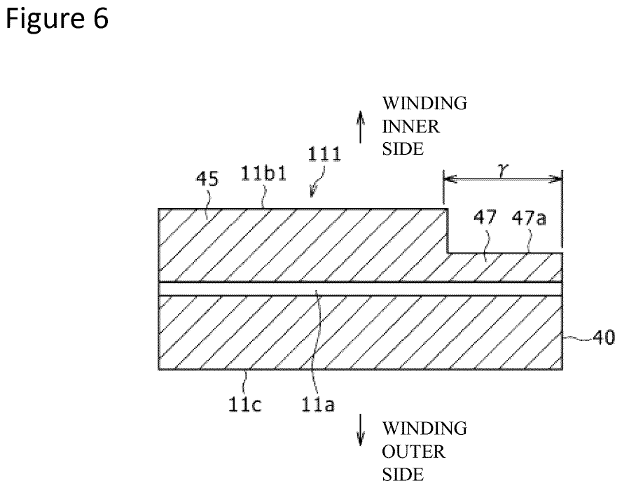

FIG. 6 is a diagram that shows a positive electrode 111 included in a cylindrical battery as another example of the embodiment and corresponds to FIG. 4. According to the configuration in this example, in the positive electrode 111, a thin portion 47 is provided at the winding-start-side end portion of the winding-inner-side positive electrode mixture layer 11b1. Specifically, the positive electrode mixture layer 11b1 includes the thin portion 47 in a predetermined range from the winding-start-side start end in the longitudinal direction (a range indicated by an arrow γ in FIG. 6).

The thickness of the thin portion 47 is less than the thickness of the main portion 45 that is a portion of the winding-inner-side positive electrode mixture layer 11b1 other than the thin portion 47. In this example, a step portion 47a is formed on the thickness-direction outer side surface (upper side surface in FIG. 6) of the winding-start-side end portion of the positive electrode mixture layer 11b1 over the entire length in the width direction (front and back direction of the sheet of FIG. 6), thus forming the thin portion 47. Accordingly, the positive electrode mixture layer 11b1 is formed as a step shape to have a thickness less than the main portion 45 at the winding-start-side end portion. In the case of this example, by the thin portion 47, the electrode reaction at the portion facing the negative electrode 12 can be prevented. Accordingly, the expansion and contraction amount during charging and discharging of the battery can be reduced. Consequently, the electrode plate deformation at the portion of the negative electrode 12 that faces the winding inner side at the winding-start-side end portion of the positive electrode 111 can be prevented.

Furthermore, the contact strength of the positive electrode mixture layer 11b1 with the positive electrode core 11a is higher at the thin portion 47 than at the main portion 45. This can prevent the thin portion 47 from being prone to peeling off the positive electrode core 11a. Consequently, the durability of the battery can be secured.

To improve the contact strength of the thin portion 47 as described above, similar to the producing method described with the configurations in FIGS. 1 to 5, the method of producing the cylindrical battery in this example forms the thin portion 47 by irradiating the longitudinal-direction predetermined range from the winding-start-side start end of the positive electrode mixture layer 11b1 with laser light. In this example, the positive electrode intermediate material is irradiated with laser light over the entire width direction so as to form a valley shape that has a rectangular section and is concave as a rectangular parallelepiped as a whole at the longitudinal-direction center portion on the surface on the winding inner side of the positive electrode intermediate material. Thus, the valley-shaped inner portion of the winding-start-side end portion of the positive electrode mixture layer 11b1 is removed by the heat of laser light, and the valley shape described above is formed. By cutting the positive electrode intermediate material at the center in the longitudinal direction, two positive electrodes 111 having the thin portion 47 are formed. In this case, the other configuration and operations are similar to the configurations in FIGS. 1 to 5.

The present disclosure is further described with the following embodiments.

### Configuration 1

A cylindrical battery, comprising an electrode assembly that includes: an elongated positive electrode that includes a positive electrode core and a positive electrode mixture layer; and an elongated negative electrode that includes a negative electrode core and a negative electrode mixture layer, the electrodes being wound with a separator intervening therebetween, wherein
the positive electrode mixture layer includes a thin portion in a predetermined range from a winding-start-side start end in a winding direction, a thickness of the thin portion is smaller than a thickness of a main portion that is a portion of the positive electrode mixture layer other than the thin portion, and a close contact strength of the positive electrode mixture layer with the positive electrode core is higher at the thin portion than at the main portion.

### Configuration 2

The cylindrical battery according to configuration 1, wherein the thin portion has a winding length that is greater than or equal to 0.05 turns and less than one turn.

### Configuration 3

The cylindrical battery according to configuration 1 or 2, wherein the thin portion is provided on a winding inner side of the positive electrode.

### Configuration 4

The cylindrical battery according to any one of configurations 1 to 3, wherein an average thickness of the thin portion in a longitudinal direction is less than or equal to 70% of the thickness of the main portion.

### Configuration 5

A method of producing the cylindrical battery according to any one of configurations 1 to 4, wherein
the thin portion is formed by irradiating the positive electrode mixture layer with laser light.

### REFERENCE SIGNS LIST

10 Cylindrical battery, 11, 111 Positive electrode, 11a Positive electrode core, 11b, 11c, 11b1 Positive electrode mixture layer, 11d Core exposed portion, 12 Negative electrode, 12a Negative electrode core, 12b, 12c Negative electrode mixture layer, 13 Separator, 14 Electrode assembly, 14a Hollow portion, 16 outer housing can, 17 Sealing assembly, 18 Upper insulating plate, 19 Lower insulating plate, 20 Positive electrode lead, 21a First negative electrode lead, 21b Second negative electrode lead, 22 Grooved portion, 23 Terminal plate, 24 Lower vent member, 25 Insulating plate, 26 Upper vent member, 27 Sealing plate, 27a Projection, 27b Vent hole, 28 Gasket, 29 Shoulder portion, 31 Bottom portion, 33 Peripheral edge portion, 39 Cylindrical portion, 40 Start end, 41 Non-facing portion, 42 Start end, 44 Thin portion, 45,451 Main portion, 46 Valley portion, 47 Thin portion, 47a Step portion, 48 Thin portion, 50 Positive electrode intermediate material

1. A cylindrical battery, comprising an electrode assembly that includes: an elongated positive electrode that includes a positive electrode core and a positive electrode mixture layer; and an elongated negative electrode that includes a negative electrode core and a negative electrode mixture layer, the electrodes being wound with a separator intervening therebetween, wherein
the positive electrode mixture layer includes a thin portion in a predetermined range from a winding-start-side start end in a winding direction, a thickness of the thin portion is smaller than a thickness of a main portion that is a portion of the positive electrode mixture layer other than the thin portion, and a close contact strength of the positive electrode mixture layer with the positive electrode core is higher at the thin portion than at the main portion.

2. The cylindrical battery according to claim 1, wherein the thin portion has a winding length that is greater than or equal to 0.05 turns and less than one turn.

3. The cylindrical battery according to claim 1, wherein the thin portion is provided on a winding inner side of the positive electrode.

4. The cylindrical battery according to claim 1, wherein an average thickness of the thin portion in a longitudinal direction is less than or equal to 70% of the thickness of the main portion.

5. A method of producing the cylindrical battery according to claim 1, wherein
the thin portion is formed by irradiating the positive electrode mixture layer with laser light.
